(19) United States
(12) Patent Application Publication
(10) Pub. No.: US 2026/0237539 A1
(43) Pub. Date: Aug. 13, 2026

(54) COMPOSITE WIRE AND ROBOT

(71) Applicant: Panasonic Intellectual Property Management Co., Ltd., Osaka (JP)

(72) Inventors: Kenshi TSUJI, Osaka (JP); Tomohiro KANAZAWA, Osaka (JP); Akitoshi KASAHARA, Osaka (JP); Yoshiyuki KITA, Osaka (JP); Tatsuya TANIWAKI, Osaka (JP)

(73) Assignee: Panasonic Intellectual Property Management Co., Ltd., Osaka (JP)

(21) Appl. No.: 19/154,278

(22) PCT Filed: Jan. 26, 2024
(86) PCT No.: PCT/JP2024/002482

§ 371 Date: Aug. 6, 2025

(30) Foreign Application Priority Data
Feb. 14, 2023 (JP) 2023-020879

(51) Int. Cl. H01B 5/10; B25J 19/00

(52) U.S. Cl. CPC H01B 5/10; B25J 19/007

(57) ABSTRACT

A composite wire is obtained by bundling a plurality of strands including a first metal wire and a second metal wire. The first metal wire includes a tungsten wire containing tungsten as a principal component, and an oxide film covering a surface of the tungsten wire. The second metal wire contains copper as a principal component. The oxide film has an average thickness of at least 2 nm and at most 50 nm. A ratio of a surface roughness Ra of the first metal wire to a wire diameter of the first metal wire is 0.0049 or lower.

### TECHNICAL FIELD

The present invention relates to composite wires and robots.

### BACKGROUND ART

Patent Literature (PTL) 1 discloses a stranded wire including a plurality of metal strands that are twisted together. In the stranded wire, metal is interposed between the metal strands and has a standard electrode potential lower than that of the metal strands.

### CITATION LIST

### Patent Literature

[PTL 1]
Japanese Patent No. 3152714

### SUMMARY OF INVENTION

### Technical Problem

When strands composed of different kinds of metals are bundled in a composite wire, such as a stranded wire, corrosion tends to occur readily due to contact between the different kinds of metals.

An object of the present invention is to provide a composite wire that can suppress corrosion even when strands composed of different kinds of metals are bundled.

### Solution to Problem

A composite wire according to an aspect of the present invention is obtained by bundling a plurality of strands including a first metal wire and a second metal wire, wherein the first metal wire includes a tungsten wire containing tungsten as a principal component, and an oxide film covering a surface of the tungsten wire, the second metal wire contains copper as a principal component, the oxide film has an average thickness of at least 2 nm and at most 50 nm, and a ratio of a surface roughness Ra of the first metal wire to a wire diameter of the first metal wire is 0.0049 or lower.

A robot according to an aspect of the present invention includes the aforementioned composite wire used as the electrical wire, the electrical wire being connected to a driver.

### Advantageous Effects of Invention

According to the present invention, corrosion can be suppressed even when strands composed of different kinds of metals are bundled.

### BRIEF DESCRIPTION OF DRAWINGS

FIG. 1 is a schematic external view illustrating a tungsten wire according to an embodiment.

FIG. 2 is a schematic cross-sectional view illustrating a stranded wire according to the embodiment.

FIG. 3 is a schematic cross-sectional view illustrating a first metal wire according to the embodiment.

FIG. 4A is a scanning-electron-microscope (SEM) image of a cross section of a sample product of the first metal wire according to the embodiment.

FIG. 4B is an image obtained by extracting an oxide film from the SEM image in FIG. 4A.

FIG. 5 is a flowchart illustrating a manufacturing method of the tungsten wire according to the embodiment.

FIG. 6 is a flowchart illustrating a corrosion test method.

FIG. 7 is a graph illustrating the relationship between a ratio of a surface roughness Ra of the first metal wire to the wire diameter of the first metal wire and a corrosion weight loss in a corrosion test of each sample product.

FIG. 8 illustrates a robot as an example of a product using the stranded wire according to the embodiment.

### DESCRIPTION OF EMBODIMENTS

Embodiments of the present invention will be described in detail below with reference to the drawings. All of the embodiments to be described below are specific examples of the present invention. Therefore, numerical values, shapes, materials, components, positions and connection methods of the components, steps, the order of the steps, and so on indicated in the embodiments below are examples, and are not intended to limit the present invention. Accordingly, among the components in the embodiments below, components not indicated in the independent claims are described as arbitrary components.

Each drawing is a schematic view and is not necessarily a precise illustration. Therefore, for example, the scales and the like in the drawings do not necessarily match. Moreover, substantially identical components in the drawings are given the same reference signs, and redundant explanations are omitted or simplified.

In this description, terms indicating the relationships between components, terms indicating the shapes of components as in, for example, circular, and numeral ranges are not expressions representing only strict meanings but rather expressions including substantially equivalent ranges, such as differences of a few percent.

### EMBODIMENT

[Stranded Wire]

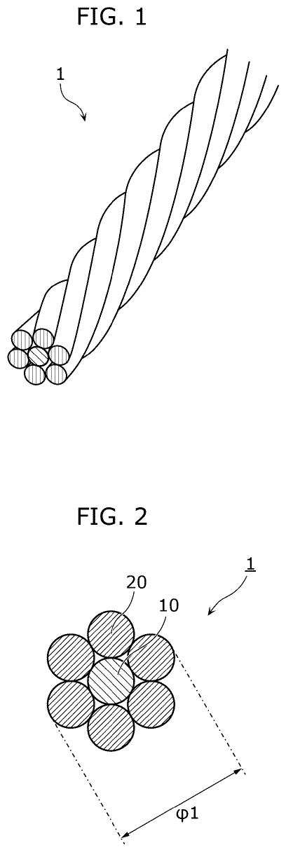

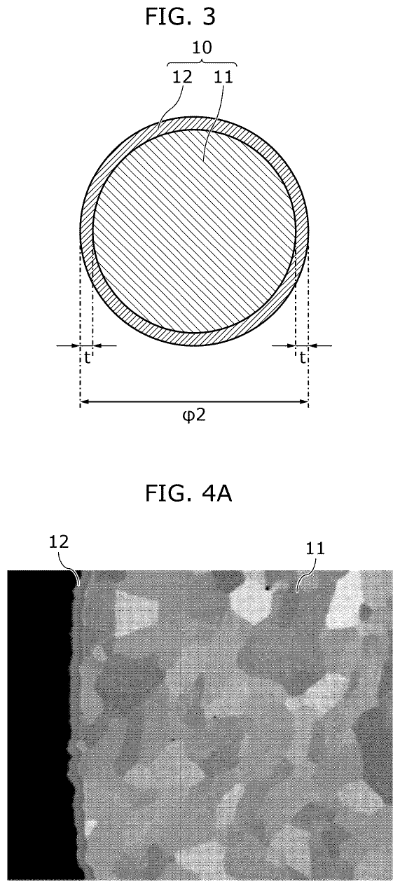

First, a stranded wire according to an embodiment will be described with reference to FIG. 1 to FIG. 3. FIG. 1 is a schematic external view illustrating stranded wire 1 according to this embodiment. FIG. 2 is a schematic cross-sectional view illustrating stranded wire 1 according to this embodiment. FIG. 3 is a schematic cross-sectional view illustrating first metal wire 10 of stranded wire 1 according to this embodiment. In FIG. 1 and FIG. 2, internal components, such as oxide film 12, of first metal wire 10 are omitted. The cross section of stranded wire 1 illustrated in FIG. 2 is taken in a direction orthogonal to an axial direction (direction in which stranded wire 1 extends) of stranded wire 1. The cross section of first metal wire 10 illustrated in FIG. 3 is taken in a direction orthogonal to an axial direction (direction in which first metal wire 10 extends) of first metal wire 10. In FIG. 3, the thickness of oxide film 12 is illustrated in an exaggerated fashion.

Stranded wire 1 illustrated in FIG. 1 and FIG. 2 is an example of a composite wire including a plurality of strands that are bundled. In detail, as illustrated in FIG. 1, stranded wire 1 is a metal stranded wire including a plurality of strands that are twisted together. For example, stranded wire 1 is stored by being wound around a reel frame also referred to as, for example, a bobbin, a reel, a spool, a drum, or the like. The storage method of stranded wire 1 is not particularly limited, and stranded wire 1 is stored in such a manner as to avoid excessive bending. The overall length of stranded wire 1 may range from the order of centimeters to the order of meters, or may be in the order of kilometers.

Stranded wire 1 is used as, for example, an electrical wire. Because first metal wire 10 including tungsten wire 11 is used as a strand in stranded wire 1, as will be described later, stranded wire 1 can achieve a reduced diameter and/or increased strength relative to a stranded wire using copper wires alone as strands. Although there is no particular limit to applications when stranded wire 1 is used as an electrical wire, for example, stranded wire 1 is used as an electrical wire connected to a driver of a robot by utilizing the fact that stranded wire 1 has a small diameter and/or high strength.

As illustrated in FIG. 2, the plurality of strands constituting stranded wire 1 include first metal wire 10 and second metal wire 20. In the example illustrated in FIG. 2, the plurality of strands include one first metal wire 10 and six second metal wires 20, and stranded wire 1 is a mixed stranded wire obtained by twisting these wires together. In stranded wire 1, first metal wire 10 is in contact with each second metal wire 20. As will be described in detail later, first metal wire 10 is a metal wire containing tungsten as a principal component and having higher tensile strength than second metal wires 20. Each second metal wire 20 is a metal wire containing copper as a principal component and having higher conductivity than first metal wire 10.

In the example illustrated in FIG. 2, stranded wire 1 is a seven-core stranded wire including seven solid wire strands that are twisted together. The number of strands constituting stranded wire 1 is not particularly limited, and stranded wire 1 may be constituted of any number of strands of various types in accordance with the desired strength and wire diameter. For example, stranded wire 1 may be a three-core stranded wire including three strands that are twisted together, a nineteen-core stranded wire including 19 strands that are twisted together, or a thirty-seven-core stranded wire including 37 strands that are twisted together. Furthermore, stranded wire 1 is not limited to a stranded wire including solid wire strands that are twisted together, and may be a stranded wire formed by being further entwined with a stranded wire including solid wires that are twisted together, as in a seven-by-seven-core stranded wire including seven seven-core stranded wires that are twisted together. Another example of such stranded wire 1 includes, but is not particularly limited to, a seven-by-nineteen-core stranded wire (including seven nineteen-core stranded wires that are twisted together), a six-by-seven-core stranded wire (including six seven-core stranded wires that are twisted together), or a three-by-seven-core stranded wire (including three seven-core stranded wires that are twisted together). The number of strands to be twisted together in the stranded wire in this case does not have to be all the same, and the stranded wire may include stranded wires including different numbers of strands that are twisted together. Although all of the strands (first metal wire 10 and multiple second metal wires 20) have the same wire diameter in the illustrated example, a combination of strands having different wire diameters may be used in stranded wire 1.

In the example illustrated in FIG. 2, one first metal wire 10 is a central strand located at the center of stranded wire 1 in the radial direction. In stranded wire 1, first metal wire 10 serving as the central strand is surrounded by the plurality of second metal wires 20 in the radial direction. In detail, stranded wire 1 is formed by winding six second metal wires 20 around first metal wire 10. Accordingly, second metal wires 20 are wound around first metal wire 10 having relatively high strength, so that stranded wire 1 has enhanced strength against bending.

The number of first metal wires 10 and second metal wires 20 included in stranded wire 1 is not particularly limited so long as stranded wire 1 includes at least one first metal wire 10 and at least one second metal wire 20 as the plurality of strands. For example, stranded wire 1 includes at least one first metal wire 10 and at least one second metal wire 20. From the standpoint of enhancing conductivity and resistance against bending, the number of second metal wires 20 may be greater than the number of first metal wires 10. The positions of first metal wire 10 and second metal wire 20 in stranded wire 1 are also not particularly limited. Specifically, the positions where the plurality of strands including first metal wire 10 and second metal wire 20 are twisted together are not limited. For example, the central strand may be second metal wire 20, and the strands surrounding the central strand may include first metal wire 10.

Wire diameter φ1 of stranded wire 1 is, for example, 500 μm or smaller, but is not limited thereto. Wire diameter φ1 of stranded wire 1 may be 400 μm or smaller, 300 μm or smaller, 200 μm of smaller, 150 μm or smaller, or 100 μm or smaller. Wire diameter φ1 of stranded wire 1 is the diameter of a circumscribed circle of the plurality of strands constituting stranded wire 1 in the cross section of stranded wire 1. In the case of the seven-core stranded wire illustrated in FIG. 2, wire diameter φ1 is the length of stranded wire 1 in the radial direction at a position where three strands are arranged in the radial direction. For example, the length of stranded wire 1 in the radial direction at the position where the three strands are arranged in the radial direction (i.e., the diameter of the circumscribed circle of stranded wire 1) is measured by using a caliper or the like at a predetermined number (e.g., two or more) of arbitrary locations, and wire diameter φ1 is calculated by averaging out the measured values.

As illustrated in FIG. 3, first metal wire 10 includes tungsten wire 11 containing tungsten as a principal component, and also includes oxide film 12 provided over the surface of tungsten wire 11.

The tensile strength of first metal wire 10 is, for example, 3500 MPa or higher, but is not limited thereto. The tensile strength of first metal wire 10 may be 4000 MPa or higher, 4500 MPa or higher, or 5000 MPa or higher. For example, first metal wire 10 with a high tensile strength of 5500 MPa or higher can also be realized.

The tensile strength of a strand, such as first metal wire 10, is obtained by dividing the breaking strength (stress at the time of breakage) of the strand by the cross-sectional area of the strand. The tensile strength is measured based on, for example, Japanese Industrial Standards JIS H 4460 8.

Since stranded wire 1 increases in tensile strength with increasing tensile strength of first metal wire 10, this is advantageous for increasing the strength of stranded wire 1. As a result, diameter reduction can be achieved while strength is maintained, so that reduced diameter and/or increased strength of stranded wire 1 can be achieved.

Wire diameter @2 of first metal wire 10 is, for example, 100 μm or smaller, but is not limited thereto. Wire diameter φ2 may be 80 μm or smaller, 60 μm or smaller, 35 μm or smaller, 30 μm or smaller, 25 μm or smaller, 20 μm or smaller, 15 μm or smaller, 13 μm or smaller, 11 μm or smaller, 10 μm or smaller, 9 μm or smaller, 8 μm or smaller, or 7 μm or smaller. For example, ultrathin first metal wire 10 with wire diameter φ2 of about 5 μm can also be realized.

As illustrated in FIG. 3, wire diameter φ2 is the sum of the diameter of tungsten wire 11 and twice average thickness t of oxide film 12. Because average thickness t of oxide film 12 is sufficiently smaller than the diameter of tungsten wire 11, wire diameter φ2 may be regarded as being substantially equal to the diameter of tungsten wire 11.

A ratio of surface roughness Ra of first metal wire 10 to wire diameter φ2 of first metal wire 10 is 0.049 or lower. Accordingly, corrosion in stranded wire 1 can be effectively suppressed. Surface roughness Ra is also referred to as “arithmetic average roughness”. Surface roughness Ra is calculated based on, for example, Japanese Industrial Standards JIS B 0601. For example, the surface of first metal wire 10 is scanned by using a laser microscope or the like, and surface roughness Ra in the circumferential direction of first metal wire 10 is calculated from the scanned data by using measurement software for surface roughness Ra.

Tungsten wire 11 contains tungsten (W) as a principal component. The term “principal component” implies that the content percentage of an element is higher than 50 mass %. For example, the content percentage of tungsten contained in tungsten wire 11 is 90 mass % or higher. The content percentage of tungsten contained in tungsten wire 11 may be 95 mass % or higher, 99 mass % or higher, 99.9 mass % or higher, or 99.99 mass % or higher. Although tungsten wire 11 is a so-called pure tungsten wire, an inevitable impurity that cannot be prevented from being mixed therein during the manufacturing process may be contained therein.

Tungsten wire 11 may be composed of an alloy of tungsten and at least one kind of metal other than tungsten. In other words, tungsten wire 11 may be a tungsten alloy wire serving as a tungsten wire composed of a tungsten alloy. The metal other than tungsten is, for example, rhenium (Re). The content percentage of rhenium contained in tungsten wire 11 composed of a rhenium-tungsten alloy (ReW) is, for example, at least 0.1 mass % and at most 10 mass %, but is not limited thereto. For example, the content percentage of rhenium may be 1 mass % or higher, 3 mass % or higher, or 5 mass % or higher.

When the content percentage of rhenium is high, the tensile strength of tungsten wire 11 can be increased. On the other hand, when the content percentage of rhenium is too high, it is difficult to achieve diameter reduction while still maintaining the high tensile strength of tungsten wire 11. In detail, wire breakage tends to occur easily, thus making wire drawing difficult over an extended length. By reducing the content percentage of rhenium and setting the content percentage of tungsten to 90 mass % or higher, the processability of tungsten wire 11 can be enhanced. Moreover, reducing the content percentage of rhenium, which is rare and expensive, enables mass production of inexpensive long tungsten wires 11.

The metal used together with tungsten in the alloy may be osmium (Os), ruthenium (Ru), or iridium (Ir). The content percentage of osmium, ruthenium, or iridium is similar to, for example, the content percentage of rhenium. In these cases, an advantage similar to the case of the rhenium-tungsten alloy can be achieved. Tungsten wire 11 may be composed of an alloy of tungsten and at least two kinds of metals other than tungsten.

Tungsten wire 11 may be a doped tungsten wire doped with potassium (K). The potassium that has been doped exists in grain boundaries of tungsten crystals. The content percentage of potassium (K) is, for example, 0.010 mass % or lower. Even with a potassium-doped tungsten wire, a metal wire having a tensile strength higher than the normal tensile strength of a piano wire can be realized. In addition to a potassium oxide, a similar effect can be achieved with an oxide of another material, such as cerium or lanthanum. Tungsten wire 11 may contain a rare earth element.

Oxide film 12 contains a tungsten oxide as a principal component. The tungsten oxide contained in oxide film 12 contains, for example, WO₃ as a principal component. Oxide film 12 may contain a tungsten oxide with a composition other than WO₃, such as WO₂ or W₃O₈. WO₂ contained in oxide film 12 tends to increase with increasing average thickness t of oxide film 12. Although stranded wire 1 includes first metal wire 10 and second metal wire 20 that are composed of different kinds of metals and that are twisted together, oxide film 12 included in first metal wire 10 contributes to suppressed corrosion.

In this embodiment, oxide film 12 is provided in the circumferential direction of the outer surface of tungsten wire 11 as well as the axial direction thereof. For example, oxide film 12 is provided over the entire outer surface of tungsten wire 11. For example, oxide film 12 provided has a uniform thickness regardless of the location. The term “uniform thickness” not only has its meaning in a strict sense, that is, means that the thickness is uniform at all locations, but also means that a thickness variation is within a predetermined range. For example, when the thickness of oxide film 12 is measured at ten arbitrary locations of first metal wire 10, a variation in the measured thickness values (percentage of a deviation from an average value) is 30% or lower.

Average thickness t of oxide film 12 is measured in the following manner.

A cross section orthogonal to the axial direction of first metal wire 10 is formed. The cross section is polished by Broad Ion Beam (BIB) processing. In detail, first metal wire 10 is irradiated with an argon ion beam, so that the irradiated area is ion-etched, whereby a smooth cross section is formed.

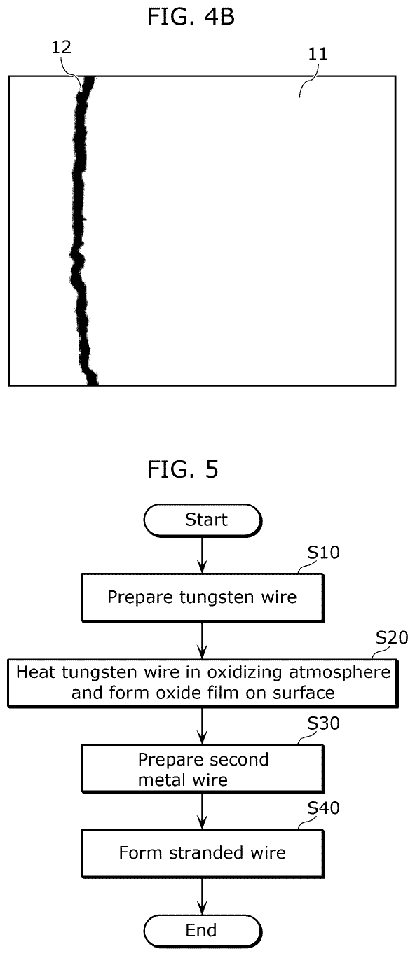

FIG. 4A is a scanning-electron-microscope (SEM) image of the cross section of first metal wire 10 according to this embodiment. FIG. 4B is an image obtained by extracting oxide film 12 from the SEM image in FIG. 4A.

As illustrated in FIG. 4A, the SEM image enables observation of tungsten crystals constituting tungsten wire 11 in accordance with differences in color. Moreover, it is apparent that oxide film 12 is formed along the surface of tungsten wire 11. Because oxide film 12 is observable in a color different from that of the tungsten crystals constituting tungsten wire 11, oxide film 12 alone can be highlighted and extracted, as illustrated in FIG. 4B.

Area S of oxide film 12 appearing in the cross section is measured by image processing. By dividing measured area S by length L of the outer circumference of tungsten wire 11, average thickness t of oxide film 12 can be calculated. Length L can be calculated from the wire diameter of tungsten wire 11 by regarding that the cross section of tungsten wire 11 is circular. Average thickness t of oxide film 12 may be calculated by averaging out thickness values of oxide film 12 measured at multiple arbitrary locations (e.g., 10 or more locations) of first metal wire 10 by using, for example, the SEM image.

In this embodiment, average thickness t of oxide film 12 is at least 2 nm and at most 50 nm. With average thickness t of oxide film 12 satisfying this range, corrosion in stranded wire 1 can be effectively suppressed. Average thickness t of oxide film 12 may be at least 5 nm and at most 50 nm, or may be at least 10 nm and at most 50 nm.

Second metal wire 20 is a copper wire containing copper (Cu) as a principal component. For example, the content percentage of copper contained in second metal wire 20 is 90 mass % or higher. The content percentage of copper contained in second metal wire 20 may be 95 mass % or higher, or 99 mass % or higher.

Second metal wire 20 may be composed of an alloy of copper and at least one kind of metal other than copper. Moreover, second metal wire 20 may contain a non-metallic element. Examples of a metal other than copper and a non-metallic element include tin (Sn), silver (Ag), silicon (Si), beryllium (Be), iron (Fe), magnesium (Mg), zirconium (Zr), zinc (Zn), chromium (Cr), phosphorus (P), titanium (Ti), aluminum (Al), arsenic (As), and nickel (Ni). By containing, for example, tin or silver, second metal wire 20 can be increased in strength. Moreover, second metal wire 20 may be plated with tin, palladium (Pd), or the like.

Normally, the tensile strength of a copper wire containing copper as a principal component is 2000 MPa or lower. By including first metal wire 10 in addition to second metal wire 20 as strands, stranded wire 1 can be increased in strength.

### [Manufacturing Method]

Next, a manufacturing method of stranded wire 1 according to this embodiment will be described with reference to FIG. 5. FIG. 5 is a flowchart illustrating the manufacturing method of stranded wire 1 according to this embodiment.

First, tungsten wire 11 having a predetermined wire diameter, tensile strength, and surface roughness Ra and containing tungsten as a principal component is prepared (S10).

For example, a tungsten ingot is first prepared. In detail, the tungsten ingot is formed by pressing and sintering tungsten powder. In this case, if a tungsten alloy wire is to be manufactured, a mixture of tungsten powder and metal powder for the alloy is pressed and sintered. In the case of a doped tungsten wire, doped tungsten powder doped with potassium or the like is pressed and sintered.

Subsequently, the prepared ingot is repeatedly swaged and heated, so as to be formed into a wire having a predetermined wire diameter (e.g., about 3 mm). An oxide layer is formed on the surface of the wire by heating, and the oxide layer is impregnated with a lubricant composed of, for example, carbon, so that breakage occurring during wire drawing (drawing process) can be suppressed.

Then, wire drawing (thinning) is performed by using a wire drawing die, such as a single-crystal diamond die or a polycrystalline diamond die. The wire drawing is performed while heating is performed. The wire drawing is repeatedly performed. In the repetition of wire drawing, adjustments are performed to gradually reduce the hole diameter of the wire drawing die and the heating temperature. Accordingly, tungsten wire 11 with high tensile strength is manufactured.

Surface roughness Ra of tungsten wire 11 is adjusted in accordance with the type of wire drawing die used. For example, surface roughness Ra of tungsten wire 11 decreases by using a single-crystal diamond die, whereas surface roughness Ra of tungsten wire 11 increases by using a polycrystalline diamond die. Since surface roughness Ra hardly changes even with oxide film 12 formed on tungsten wire 11, as will be described later, surface roughness Ra of first metal wire 10 is adjustable by adjusting surface roughness Ra of tungsten wire 11.

Finally, an adjustment to a desired wire diameter is performed by electrolytic polishing. For example, in a state where tungsten wire 11 and a counter electrode are immersed in an electrolytic solution, such as a sodium hydroxide solution, electrolytic polishing is performed by applying voltage between tungsten wire 11 and the counter electrode. The electrolytic polishing may be omitted.

Then, in order to remove impurities, moisture, and other substances adhered in the electrolytic polishing, heating is performed under a reducing atmosphere. The heating temperature is, for example, at least 600° C. and at most 1400° C. Subsequently, oxide film 12 is formed on the surface of prepared tungsten wire 11 (S20). Accordingly, first metal wire 10 is obtained. Oxide film 12 is formed by heating tungsten wire 11 after the wire drawing process under an oxidizing atmosphere. By adjusting the partial pressure of inert gas in the oxidizing atmosphere, average thickness t of oxide film 12 can be controlled. The inert gas is, for example, nitrogen gas or argon gas. Average thickness t of oxide film 12 can also be controlled by adjusting the heating temperature and the heating time. In detail, average thickness t of oxide film 12 increases with decreasing partial pressure of inert gas, increasing heating temperature, or increasing heating time. The heating temperature is, for example, at least 200° C. and at most 1200° C., but is not limited thereto.

For example, tungsten wire 11 before being heated has undergone electrolytic polishing, so that the oxide layer adhered to the surface thereof during the wire drawing has been removed. Accordingly, a thickness variation in oxide film 12 to be formed on the surface can be suppressed, and oxide film 12 with excellent film quality can be formed.

Subsequently, second metal wire 20 having a predetermined wire diameter and tensile strength and containing copper as a principal component is prepared (S30). For example, an industrial copper wire may be used as second metal wire 20. For example, an industrial copper wire having a desired wire diameter and tensile strength is acquired. Step S30 may be performed at any timing so long as the timing is prior to step S40 described below.

Then, stranded wire 1 is formed by twisting together first metal wire 10 obtained in step S20 and second metal wire 20 prepared in step S30 (S40). Stranded wire 1 is formed by twisting together a plurality of strands including at least one first metal wire 10 and at least one second metal wire 20. For example, in the case where stranded wire 1 is a seven-core stranded wire illustrated in FIG. 2, one first metal wire 10 serves as a central strand located at the center of stranded wire 1, and stranded wire 1 is formed by winding six second metal wires 20 around the central strand. The winding direction in this case is not particularly limited, and may be S-twisting or Z-twisting.

### [Corrosion Test]

The following description relates to a corrosion test performed for confirming a corrosion suppression effect in stranded wire 1.

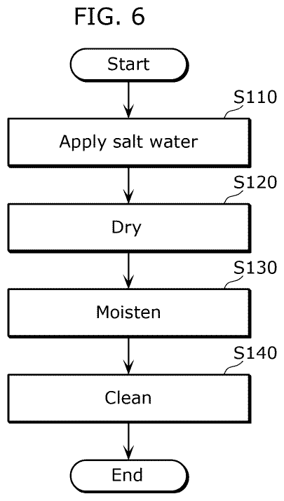

FIG. 6 is a flowchart illustrating a corrosion test method. The corrosion test involves first preparing a sample product for the corrosion test and immersing the prepared sample product in salt water for two hours at 35° C. to cause the salt water to adhere to the sample product (S110).

With regard to the sample product for the corrosion test, the sample product used is obtained by tightly winding one first metal wire 10 around an industrially-available copper stranded wire including 10 flexible copper wires that are twisted together. With regard to the copper stranded wire used, the wire diameter of each flexible copper wire is 50 μm, the wire diameter of the copper stranded wire is 230 μm, and the tensile strength of the copper stranded wire is 245 MPa. The tensile strength of the copper stranded wire is calculated by dividing the breaking strength by the cross-sectional area of the 10 flexible copper wires. First metal wire 10 used will be described later.

Subsequently, the sample product with the salt water adhered thereto is inserted into a test tank and is dried for four hours at 60° C. and at a humidity of 20% RH to 30% RH (S120). Then, the dried sample product is moistened for 30 minutes at 50° C. and at a humidity of 95% RH or higher (S130). Finally, the moistened sample product is rinsed in pure water and is ultrasonically cleaned for 30 minutes, whereby a corrosion-tested sample product is obtained (S140). Accordingly, the corrosion test causes corrosion to accelerate in accordance with the salt, water, and temperature. Because a corroded section is removed by cleaning, a corroded sample product decreases in weight after the corrosion test.

For evaluating corrosion, the weight of the sample product prior to the corrosion test and the weight of the sample product after the corrosion test are measured, and a weight loss ratio of the sample product due to the corrosion test is calculated as a corrosion weight loss. In other words, (corrosion weight loss)=(pre-test weight-post-test weight)/pre-test weight.

Next, results of the corrosion test performed on sample products using actually-fabricated first metal wires 10 will be described with reference to Table 1 to Table 3 and FIG. 7.

The present inventors have fabricated sample products using 14 first metal wires 10 with different combinations of wire diameter φ2, surface roughness Ra, and average thickness t of oxide film 12, and have performed the aforementioned corrosion test on each sample product. With regard to each sample product, wire diameter φ2 of first metal wire 10, surface roughness Ra thereof, and average thickness t of oxide film 12, as well as the corrosion weight loss, are as indicated in Table 1. Wire diameter φ2 is a value obtained by adjusting the hole diameter of the wire drawing die and the electrolytic polishing conditions in accordance with first metal wire 10 used in each sample product, and measuring wire diameter φ2 of first metal wire 10 obtained. Surface roughness Ra is a value obtained by changing the type of wire drawing die used for forming tungsten wire 11 in accordance with first metal wire 10 used in each sample product, and measuring surface roughness Ra of first metal wire 10 obtained. Average thickness t of oxide film 12 is a value obtained by adjusting the partial pressure of inert gas, the heating temperature, and the heating time for forming oxide film 12 in accordance with first metal wire 10 used in each sample product, and measuring average thickness t of oxide film 12 obtained. In Table 1, average thickness t of “2-10 [nm]” indicates that, when oxide film 12 with target average thickness t of about 5 nm is to be formed, oxide film 12 with average thickness t ranging between 2 nm and 10 nm is formed. The tensile strength of first metal wire 10 with wire diameter φ2 of 20 μm is 3750 MPa. The tensile strength of first metal wires 10 with wire diameters φ2 of 30, 33, and 50 μm is 3550 MPa. The sample products used in the test are adjusted to have the same length for the copper stranded wires used and the same length for first metal wires 10 used.

In Table 1 shown below, a ratio of surface roughness Ra of first metal wire 10 to wire diameter φ2 of first metal wire 10 (sometimes referred to as “Ra/wire diameter φ2” hereinafter) is also indicated in addition to wire diameter φ2 of first metal wire 10, surface roughness Ra of first metal wire 10, average thickness t of oxide film 12, and the corrosion weight loss. Moreover, Table 1 indicates the corrosion weight loss results of the respective sample products such that Ra/wire diameter φ2 decreases from the upper side toward the lower side.

TABLE 1

| Wire | | Average | | |
|---|---|---|---|---|
| diameter φ2 | | thickness t | Ra/Wire | Corrosion |
| [μm] | Ra [μm] | [nm] | diameter φ2 | weight loss |
| 33 | 0.17 | 90 | 0.0052 | 1.4% |
| 30 | 0.15 | 90 | 0.0050 | 1.4% |
| 20 | 0.10 | 2-10 | 0.0050 | 1.5% |
| 33 | 0.16 | 50 | 0.0048 | 1.0% |
| 30 | 0.14 | 50 | 0.0047 | 0.9% |
| 33 | 0.15 | 2-10 | 0.0045 | 0.7% |
| 30 | 0.13 | 2-10 | 0.0043 | 0.6% |
| 33 | 0.14 | 2-10 | 0.0042 | 0.9% |
| 30 | 0.12 | 50 | 0.0040 | 0.7% |
| 50 | 0.19 | 2-10 | 0.0038 | 0.4% |
| 30 | 0.11 | 2-10 | 0.0037 | 0.2% |
| 33 | 0.08 | 90 | 0.0024 | 1.2% |
| 33 | 0.07 | 50 | 0.0021 | 0.5% |
| 33 | 0.06 | 2-10 | 0.0018 | 0.5% |

In Table 2 shown below, the corrosion weight loss result of each sample product shown in Table 1 is indicated for each combination of Ra/wire diameter φ2 (column) and average thickness t of oxide film 12 (row).

TABLE 2

| Ra/Wire | Average thickness t | | |
|---|---|---|---|
| diameter φ2 | 2 nm-10 nm | 50 nm | 90 nm |
| 0.0052 | | | 1.4% |
| 0.0050 | 1.5% | | 1.4% |
| 0.0048 | | 1.0% | |
| 0.0047 | | 0.9% | |
| 0.0045 | 0.7% | | |
| 0.0043 | 0.6% | | |
| 0.0042 | 0.9% | | |
| 0.0040 | | 0.7% | |
| 0.0038 | 0.4% | | |
| 0.0037 | 0.2% | | |
| 0.0024 | | | 1.2% |
| 0.0021 | | 0.5% | |
| 0.0018 | 0.5% | | |

FIG. 7 is a graph illustrating the relationship between Ra/wire diameter φ2 and the corrosion weight loss in the corrosion test of each sample product. In FIG. 7, the abscissa axis denotes Ra/wire diameter φ2 in first metal wire 10 of each sample product, whereas the ordinate axis denotes the corrosion weight loss of each sample product. FIG. 7 is a graphical representation of Table 1 and Table 2. In FIG. 7, the result of each sample product using first metal wire 10 with average thickness t ranging between 2 nm and 10 nm is indicated with a circular marker, the result of each sample product using first metal wire 10 with average thickness t of 50 nm is indicated with a rectangular marker, and the result of each sample product using first metal wire 10 with average thickness t of 90 nm is indicated with a triangular marker.

The present inventors have also performed the aforementioned corrosion test on sample products, in place of the above sample products, including a copper stranded wire alone, tungsten wire 11 alone that has not undergone a process for forming oxide film 12, and tungsten wire 11, which has not undergone a process for forming oxide film 12, wound around a copper stranded wire. The results are as shown in Table 3.

TABLE 3

| Sample product | Corrosion weight loss |
|---|---|
| Copper stranded wire | 0.1% |
| alone | |
| Tungsten wire 11 alone | 0.0% |
| Copper stranded wire + | 1.7% |
| tungsten wire 11 | |

In the case of the copper stranded wire alone and tungsten wire 11 alone as indicated in Table 3, corrosion hardly occurs as a result of the corrosion test. In contrast, in the sample product including wound tungsten wire 11 that has not undergone a process for forming oxide film 12, corrosion caused by the corrosion test is significant, and the weight has decreased greatly. This is because corrosion tends to occur readily due to contact between different kinds of metals.

On the other hand, as shown in Table 1, Table 2, and FIG. 7, in each sample product obtained by winding first metal wire 10, which includes tungsten wire 11 and oxide film 12 formed thereon, around a copper stranded wire, corrosion caused by the corrosion test is suppressed. This is presumably because oxide film 12 formed on first metal wire 10 suppresses contact between tungsten wire 11 and the copper wire.

It is also confirmed in each sample product that the corrosion weight loss tends to decrease with decreasing Ra/wire diameter @2. With regard to the sample products, the sample products with average thickness t of oxide film 12 ranging between 2 nm and 10 nm and at 50 nm have no differences in the corrosion weight loss, and have a smaller corrosion weight loss than the sample product with average thickness t of oxide film 12 at 90 nm. In particular, in a sample product having average thickness t of oxide film 12 ranging between 2 nm and 10 nm or at 50 nm and having Ra/wire diameter φ2 of 0.0049 or lower (single-dot chain line extending in the vertical direction in FIG. 7), the corrosion weight loss (single-dot chain line extending in the horizontal direction in FIG. 7) is 1.0% or lower, so that significant corrosion suppression is confirmed. This is presumably because, in addition to oxide film 12 suppressing contact between tungsten wire 11 and the copper wire, surface roughness Ra of first metal wire 10 and average thickness t of oxide film 12 have caused the standard electrode potential of first metal wire 10 to change, thus reducing a standard electrode potential difference between first metal wire 10 and the copper stranded wire.

In the sample product with average thickness t of oxide film 12 at 90 nm, a significant corrosion suppression effect is not confirmed even with reduced Ra/wire diameter φ2. In other words, the corrosion weight loss cannot be controlled even by adjusting Ra/wire diameter φ2. This is presumably because, when the average thickness t of oxide film 12 becomes larger than 90 nm, the standard electrode potential of first metal wire 10 is less likely to change even with the change in surface roughness Ra of first metal wire 10.

Accordingly, by setting average thickness t of oxide film 12 in a range between at least 2 nm and at most 50 nm and setting Ra/wire diameter φ2 to 0.0049 or lower, the corrosion weight loss of a sample product significantly decreases, so that corrosion of the sample product is apparently suppressed.

Although the above corrosion test is performed by using sample products each obtained by winding first metal wire 10 around a copper stranded wire, it may be regarded that effects similar to those of the above test can be achieved so long as the stranded wire, such as stranded wire 1, includes first metal wire 10 and second metal wire 20 as a plurality of strands.

### EFFECTS, ETC.

As described above, stranded wire 1 according to this embodiment is obtained by bundling a plurality of strands including first metal wire 10 and second metal wire 20. First metal wire 10 includes tungsten wire 11 containing tungsten as a principal component, and also includes oxide film 12 that covers the surface of tungsten wire 11. Second metal wire 20 contains copper as a principal component. Oxide film 12 has average thickness t of at least 2 nm and at most 50 nm. A ratio of surface roughness Ra of first metal wire 10 to wire diameter @2 of first metal wire 10 is 0.0049 or lower.

Accordingly, corrosion can be suppressed even in the case of a bundle of strands that are composed of different kinds of metals and that are twisted together, as in stranded wire 1. Furthermore, with stranded wire 1 including first metal wire 10 as a strand, a reduced diameter and/or increased strength can be achieved.

Moreover, for example, wire diameter φ2 of first metal wire 10 may be 100 μm or smaller.

Accordingly, since the specific surface area of first metal wire 10 increases when wire diameter φ2 is small, the corrosion suppression effect by oxide film 12 is more effective. In addition, first metal wire 10 can be readily increased in strength.

Furthermore, for example, first metal wire 10 may be located at the center of stranded wire 1 in the radial direction.

Accordingly, the strength of stranded wire 1 can be increased in a well-balanced manner. Since second metal wire 20, which is relatively soft, is located outside first metal wire 10, stranded wire 1 can have enhanced strength against bending.

Furthermore, for example, stranded wire 1 may be used as an electrical wire.

Accordingly, with stranded wire 1 including first metal wire 10 as a strand, the electrical wire can be reduced in diameter and/or increased in strength, while corrosion of the electrical wire can be suppressed.

### Usage Example

Next, an example of a product using stranded wire 1 according to the above embodiment will be described.

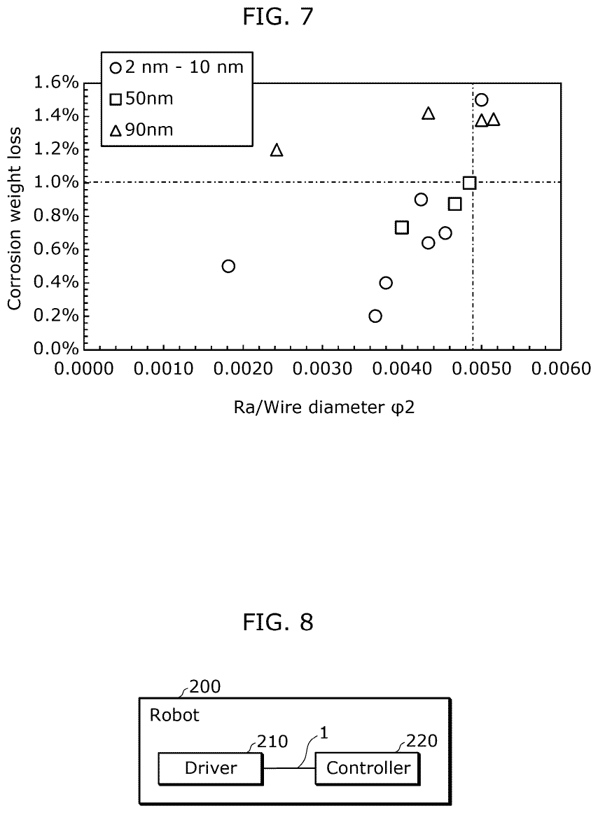

FIG. 8 illustrates robot 200 as an example of a product using stranded wire 1 according to this embodiment.

As illustrated in FIG. 8, robot 200 includes driver 210, controller 220, and stranded wire 1 as an electrical wire connected to driver 210. Robot 200 is, for example, a factory automation robot. Robot 200 may be a robot other than that for factory automation, such as an autonomous mobile robot.

In robot 200, stranded wire 1 is used as an electrical wire connected to driver 210. Driver 210 includes a driving mechanism including a motor, an actuator, or the like and operates based on a control signal from controller 220. The control signal is transmitted from controller 220 to driver 210 via stranded wire 1 serving as an electrical wire that connects driver 210 and controller 220 to each other. In other words, stranded wire 1 is a signal wire connected to driver 210 and for transmitting a signal.

Controller 220 controls the operation of driver 210. Controller 220 is, for example, a control device including a processor or a microcomputer.

As mentioned above, stranded wire 1 can be reduced in diameter and/or increased in strength, while corrosion is suppressed. Therefore, the use of stranded wire 1 as the electrical wire connected to driver 210 in robot 200 enables size reduction and/or high load tolerance of robot 200, and also enables enhanced durability and reliability of robot 200 since stranded wire 1 is resistant to corrosion.

Stranded wire 1 connected to driver 210 may be used as an electrical wire for supplying driving electric power to driver 210. Similar to the above, this also enables size reduction and/or high load tolerance of robot 200, and also enables enhanced durability and reliability thereof. When stranded wire 1 is used as an electrical wire for supplying electric power, stranded wire 1 may be connected to controller 220, as illustrated in FIG. 8, so as to supply the electric power to driver 210 via controller 220, or stranded wire 1 serving as an electrical wire that connects another power supply circuit or an external power source (not shown) to driver 210 may be included in robot 200.

Stranded wire 1 may be used as an electrical wire included in a product, such as a household appliance, an analysis device, or production equipment, other than a robot. Accordingly, a product using stranded wire 1 can be reduced in size and/or made tolerant against high load, and can also achieve enhanced durability and reliability.

### MISCELLANEOUS

Although the composite wire according to the present invention has been described above based on the above embodiment, the present invention is not to be limited to the above embodiment.

For example, although stranded wire 1 is described as an example of a composite wire in the above embodiment, the composite wire according to the present invention is not limited to a stranded wire as an example. The composite wire according to the present invention is not particularly limited so long as it is a composite wire in which a plurality of strands including first metal wire 10 and second metal wire 20 are collectively bundled. For example, in the composite wire according to the present invention, the plurality of strands may be bundled by a covering process, may be bundled by using a binder, or may be bundled by using an insulating coating. Because the plurality of strands constituting the composite wire include first metal wire 10 and second metal wire 20, corrosion can be suppressed even in the case of a bundle of strands that are composed of different kinds of metals.

The present invention encompasses modes conceivable by a skilled person and obtained by variously modifying each of the embodiment and the variations of the embodiment, as well as modes achieved by arbitrarily combining the components and functions in each of the embodiment and the variations of the embodiment, so long as the modes do not depart from the scope of the present invention.

Examples of the composite wire and the robot according to the present invention described based on the above embodiment are indicated below. The stranded wire and the robot according to the present invention are not to be limited to the following examples.

For example, a composite wire according to a first aspect of the present invention is obtained by bundling a plurality of strands including a first metal wire and a second metal wire. The first metal wire includes a tungsten wire containing tungsten as a principal component, and an oxide film covering a surface of the tungsten wire, the second metal wire contains copper as a principal component, the oxide film has an average thickness of at least 2 nm and at most 50 nm, and a ratio of a surface roughness Ra of the first metal wire to a wire diameter of the first metal wire is 0.0049 or lower.

Furthermore, for example, a composite wire according to a second aspect of the present invention is the composite wire according to the first aspect in which, the first metal wire has a wire diameter of 100 μm or smaller.

Furthermore, for example, a composite wire according to a third aspect of the present invention is the composite wire according to the first or second aspect in which, the first metal wire is located at a center of the composite wire in a radial direction.

Furthermore, for example, a composite wire according to a fourth aspect of the present invention is the composite wire according to any one of the first to third aspects in which, the composite wire is used as an electrical wire.

Furthermore, for example, a robot according to a fifth aspect of the present invention includes the composite wire according to any one of the first to fourth aspects used as the electrical wire, the electrical wire being connected to a driver.

Furthermore, for example, the robot according to a sixth aspect of the present invention is the robot according to the fifth aspect in which, the electrical wire is a signal wire connected to the driver.

### REFERENCE SIGNS LIST

1 stranded wire (composite wire)
10 first metal wire
11 tungsten wire
12 oxide film
20 second metal wire
200 robot
210 driver

1. A composite wire obtained by bundling a plurality of strands including a first metal wire and a second metal wire, wherein
the first metal wire includes a tungsten wire containing tungsten as a principal component, and an oxide film covering a surface of the tungsten wire,
the second metal wire contains copper as a principal component,
the oxide film has an average thickness of at least 2 nm and at most 50 nm, and
a ratio of a surface roughness Ra of the first metal wire to a wire diameter of the first metal wire is 0.0049 or lower.

2. The composite wire according to claim 1, wherein
the first metal wire has a wire diameter of 100 μm or smaller.

3. The composite wire according to claim 1, wherein
the first metal wire is located at a center of the composite wire in a radial direction.

4. The composite wire according to claim 1, wherein
the composite wire is used as an electrical wire.

5. A robot comprising:
the composite wire according to claim 4 used as the electrical wire, the electrical wire being connected to a driver.

6. The robot according to claim 5, wherein
the electrical wire is a signal wire connected to the driver.
